(19) United States
(12) Patent Application Publication
(10) Pub. No.: US 2021/0009788 A1
(43) Pub. Date: Jan. 14, 2021

(54) Functionalized Carbon Black for Interaction with Liquid or Polymer Systems

(71) Applicant: Birla Carbon U.S.A., Inc., Marietta, GA (US)

(72) Inventors: Charles R Herd, Woodstock, GA (US); Zachary A COMBS, Smyrna, GA (US)

(73) Assignee: Birla Carbon U.S.A., Inc., Marietta, GA (US)

(21) Appl. No.: 16/624,462

(22) PCT Filed: Jun. 21, 2018
(86) PCT No.: PCT/US2018/038732

§ 371 Date: Dec. 19, 2019

Related U.S. Application Data
(60) Provisional application No. 62/522,958, filed on Jun. 21, 2017.

(51) Int. Cl. C08K 9/02; B60C 1/00; C09C 1/56; C09D 11/037; C09D 7/62; C08K 3/04

(52) U.S. Cl. CPC C08K 9/02; B60C 1/00; C09C 1/565; C01P 2006/80; C09D 7/62; C08K 3/04; C09D 11/037

(57) ABSTRACT

A functionalized carbon black optimized for statistically beneficial interaction with a liquid and/or polymer system, and methods for preparing and using the same.

### BACKGROUND

### Technical Field

The present disclosure relates to carbon blacks, and specifically to functionalized carbon blacks, together with methods for the manufacture and use thereof.

### Technical Background

Carbon blacks have been functionalized with many different chemical moieties, ranging from adsorbed molecules, oligomer grafts, and specific functional groups that are covalently bonded. As is well known in the art, normally this functionalization is considered to occur on the edge sites of graphene planes at the surface of the carbon black. These graphene planes manifest themselves as overlapping tiles, in fact the outer surface is considered to be the final layer of numerous graphene layers, arranged in an onion skin orientation that form the fundamental building blocks of the carbon black particle. This paracrystalline microstructure has been confirmed by phase contrast and electron diffraction transmission electron microscope imaging, and has been further confirmed by x-ray diffraction.

In terms of the functional groups at the edges of these graphene layers at the carbon black surface, it is well known that they comprise a mixture of various oxygen-based functional groups and hydrogen, representing a heterogeneous surface chemistry of varied acidity and basicity. Frequently, a certain type of functional group is utilized as a reaction site for differentiated surface chemistry/surface activity, but its efficacy can be limited due to the heterogeneous nature of the inherent surface functionality as manufactured. This is especially true for the carbon blacks made by the furnace process, which have a rather low level of surface functionality, typically containing 1% or less of oxygen and hydrogen at the surface.

As such, it has become important to improve the surface functionality of carbon black with increased surface group concentrations and more uniform surface chemistry, as much as can be realistically obtained. On the other hand completely covering the surface of carbon black particles with functional groups may not be necessary, may make the functionalized carbon black too reactive, and may require significant energy and highly intensive treatment to add higher and higher levels of functional groups. Thus, a reasonable balance may be to simply ensure that each available graphene layer edge site capable of being functionalized, is done so with a chosen moiety. In this case such a moiety can be represented by various oxidants, since it is well known to those in the art (of carbon) that the carbon black surface and its graphene layer edge sites are quite susceptible to oxidation.

Additionally the level of oxidation needs to be easily controlled and it is preferable not to generate porosity from the oxidation, but this can be a challenge to balance the high degree of oxidation required to functionalize each edge site, yet minimize or all together prevent porosity development. Thus achieving the practically complete oxidation of edge sites with minimal porosity is a technical challenge that perhaps has not been recognized previously. Of course the goal of such rich and significant functionalization is to provide a carbon black surface with a significantly improved probability of interaction with liquid or polymer systems, non-functionalized or functionalized, via van der Waals, hydrogen, free radical or covalent bonding, depending upon the chemistry of the vehicle system. This approach can have significant benefits in terms of improving and stabilizing carbon black dispersions, both macro and micro and reducing flocculation and networking. The benefits of this approach may be realized in terms of improved color performance in coatings or inks (increased blackness or jetness) and lower hysteresis in rubber compounds.

Thus, there is a need for improved functionalized carbon black and methods for manufacturing and using the same. These needs and other needs are satisfied by the compositions and methods of the present disclosure.

### SUMMARY

In accordance with the purpose(s) of the invention, as embodied and broadly described herein, this disclosure, in one aspect, relates to carbon blacks, and specifically to functionalized carbon blacks, together with methods for the manufacture and use thereof

In one aspect, the present disclosure provides a functionalized carbon black composition and methods for preparing a functionalized carbon black composition.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates a carbon black surface model having graphitic crystallite building blocks, in accordance with various aspects of the present disclosure.

FIG. 2 illustrates a carbon black surface model having an onion skin orientation of graphene layers, in accordance with various aspects of the present disclosure.

FIG. 3A illustrates the nitrogen surface area (NSA) as a function of volatile content for an ASTM N234 grade carbon black, as a result of oxidation with nitric acid, hydrogen peroxide, and ozone, in accordance with various aspects of the present disclosure.

FIG. 3B illustrates the statistical thickness surface area (non-porous surface area) as a function of volatile content for an ASTM N234 grade carbon black, as a result of oxidation with nitric acid, hydrogen peroxide, and ozone, in accordance with various aspects of the present disclosure.

FIG. 3C illustrates the oxygen content for an ASTM N234 grade carbon black, as a function of volatile content, in accordance with various aspects of the present disclosure.

FIG. 4 illustrates the ultimate level of oxidation (non-porous) of various carbon black samples, in accordance with various aspects of the present disclosure.

FIG. 5 illustrates an exemplary schematic of the typical arrangement of hydrogen and oxygen based functional groups on a carbon black surface, located at edge sites of the graphene surface layers, in accordance with various aspects of the present disclosure.

FIG. 6 illustrates data from x-ray photoelectron spectroscopy (XPS) for an ASTM N234 grade carbon black, showing changes in functional group types and ratios with increasing oxidation, in accordance with various aspects of the present disclosure.

FIG. 7 illustrates models for 50% overlap of graphene layers having varying Lₐ sizes, in accordance with various aspects of the present disclosure.

FIG. 8 illustrates a summary plot of edge site availability with varying Lₐ size for the Paracrystalline Overlap Model, in accordance with various aspects of the present disclosure.

FIG. 9 illustrates models for varying graphene layer overlap, each having a Lₐ value of 2 nm, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described. Test methods not specifically described herein reference conventional ASTM methods used in the carbon black industry. Unless cited to the contrary, the methods are intended to refer to the latest version currently employed at the time of this application in the carbon black industry, and to any options or preferences conventionally used

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

As used herein, unless specifically stated to the contrary, the abbreviation “phr” is intended to refer to parts per hundred, as is typically used in the rubber industry to describe the relative amount of each ingredient in a composition.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides methods for determining the equilibrium volatile level (or breakpoint volatile level) for functionalized carbon blacks, together with methods for preparing and utilizing such oxidized carbon blacks. Also disclosed are the oxidized carbon blacks prepared by such methods. In one aspect, the disclosure provides methods to determine the optimal level of functionalization or volatile content for a specific grade of carbon black. In another aspect, the disclosure provides methods to treat a carbon black, so as to functionalize the carbon black to a predetermined target value of functionalization. In yet other aspects, the disclosure provides carbon blacks that have been treated and contain an optimal level of functionalization. As used herein, the terms “equilibrium value,” “optimum value,” and “breakpoint,” unless specifically stated to the contrary, are intended to refer to levels of functionalization, for example, oxidation, wherein all of the available edge sites on the surface graphene layers of the carbon black are functionalized, but wherein no or substantially no additional functionalization has occurred that could result in a change in surface porosity and/or morphology.

In various aspects, a carbon black, such as, for example, a furnace carbon black, can be selected, and one or more of the models described herein, used to determine the equilibrium volatile level where all available edge sites are functionalized, without adding any significant increase in porosity. In one aspect, the carbon black can subsequently be treated, for example, by ozonation, to impart the equilibrium level of volatile content to the carbon black surface. In one aspect, such a carbon black can comprise at least about 80% of the equilibrium volatile content (i.e., wherein at least 80% of the available edge sites are functionalized). In other aspects, such a carbon black can comprise at least about 85%, 90%, 95%, 98%, 99%, 100%, 105%, 110%, 115%, 120%, 125%, 130%, 135%, 140%, 145% and, 150% or more of the equilibrium volatile content, as determined by one or more of the models described herein.

It should be noted that the carbon black of the present disclosure can comprise any carbon black. In one aspect, the carbon black can comprise a furnace carbon black. In another aspect, the carbon black, prior to oxidation, can comprise an ASTM grade carbon black, such as, for example, N134, N121, N115, N110, N220, N234, N299, N330, N339, N550, N539, N660, N762, N772, or N990.

In other aspects, the models used herein, can be used to determine a target volatile level during an oxidation process, such that all or a portion of the surface can be functionalized without adding any or any significant level of porosity.

For the methods described herein, any suitable functionalization method or combination of methods can be employed. For example, for oxidation treatments, ozone, acid, for example, nitric acid, and peroxide, and/or combinations of these or other treatments can be employed. Such treatments can be performed in-situ during a portion of the manufacturing process or as a post-treatment process, for example, either in a batch or continuous process. In one aspect, a treatment, such as, for example, ozone treatment, can be performed in a rotating drum or fluidized bed as a post-treatment process.

Carbon blacks have been functionalized with many different chemical moieties, ranging from adsorbed molecules, oligomer grafts, and specific functional groups that are covalently bonded. This functionalization is generally believed to occur on the edge sites of graphene planes at the surface of the carbon black.

For various applications, it has become important to improve the surface functionality of carbon black with increased surface group concentrations and more uniform surface chemistry, as much as can be realistically obtained. It should also be understood that completely covering the surface of carbon black particles with functional groups may not be necessary and may make the resulting carbon black too reactive and requiring significant energy and highly intensive treatments to add higher and higher levels of functional groups. While not wishing to be bound by theory, it is now believed that an ideal balance is to functionalize each available graphene layer edge site capable of being functionalized.

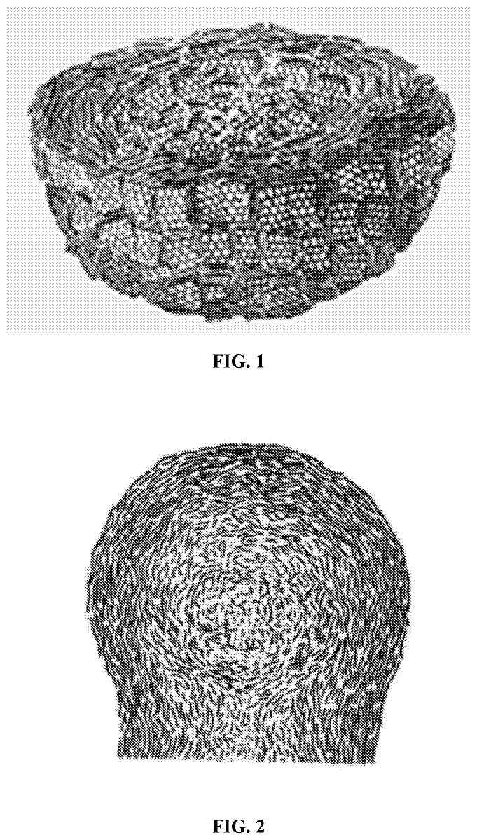

There are various models to describe the carbon black surface. In one aspect, a model assumes a random orientation of ordered groupings of graphene layers, as illustrated in FIG. 1. In this model, it is assumed that there is little or no overlap in graphene layers, such that all or virtually all edge sites are available for reaction and/or functionalization. It is also assumed in this model that Lₐ, the bulk average x−y dimension of the stacked graphene layers as determined from X-ray diffraction spectroscopy (XRD) or Raman spectroscopy, represents the average x−y graphene layer size at the surface. In a second model, the carbon black surface can be represented as an onion-skin orientation of graphene layers, as illustrated in FIG. 2. In this second model, a random orientation of graphene layers is assumed, demonstrating a degree of short range graphitic order, but with graphene layer spacing slightly larger than graphite due to the paracrystalline nature of the stacking. In this model, it is also assumed that the graphene layers overlap one another at the surface in a tile-like manner, such that only a certain number of edge sites are available for functionalization, depending on the degree of overlap. As in the first model, it is also assumed that Lₐ, the bulk average x−y dimension of the stacked graphene layers as determined from X-ray diffraction (XRD) or Raman spectroscopy, represents the average x−y graphene layer size at the surface.

Oxidation of carbon black is well known and today oxidized carbon blacks are sold commercially into the inks and coatings markets. Several methods for oxidizing carbons exist, from a chemical treatment standpoint and include oxidation via ozone (U.S. Pat. No. 3,245,820), nitric acid (U.S. Pat. No. 3,336,148), and hydrogen peroxide (U.S. Pat. No. 6,120,594), among many other potential oxidants, each of which are hereby incorporated by reference for the purpose of teaching oxidation methods.

For commercially useful oxidized carbon blacks, the level of oxidation needs to be controlled. In addition, it is generally preferable to not generate porosity from the oxidation. This can be challenging, especially given the high degree of oxidation required to functionalize each edge site. Thus, achieving the complete or substantially complete oxidation of edge sites with minimal porosity is a technical challenge that perhaps has not been recognized previously. Of course the goal of such rich and significant functionalization is to provide a carbon black surface with a significantly improved probability of interaction with liquid or polymer systems, non-functionalized or functionalized, via van der Waals, hydrogen, free radical or covalent bonding, depending upon the chemistry of the vehicle system. This approach can have significant benefits in terms of improving and stabilizing carbon black dispersions, both macro and micro and reducing flocculation and networking. The benefits of this approach can be realized in terms of improved color performance in coatings or inks (increased blackness or jetness) and lower hysteresis in rubber compounds.

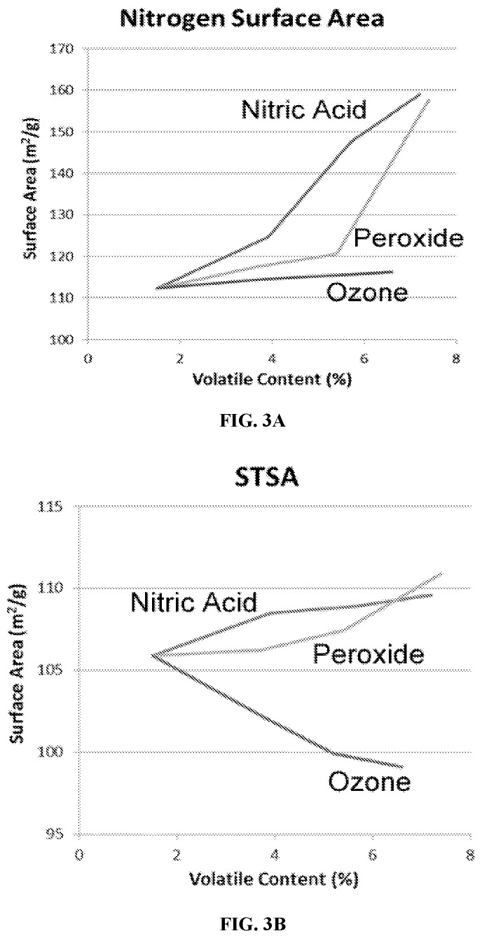

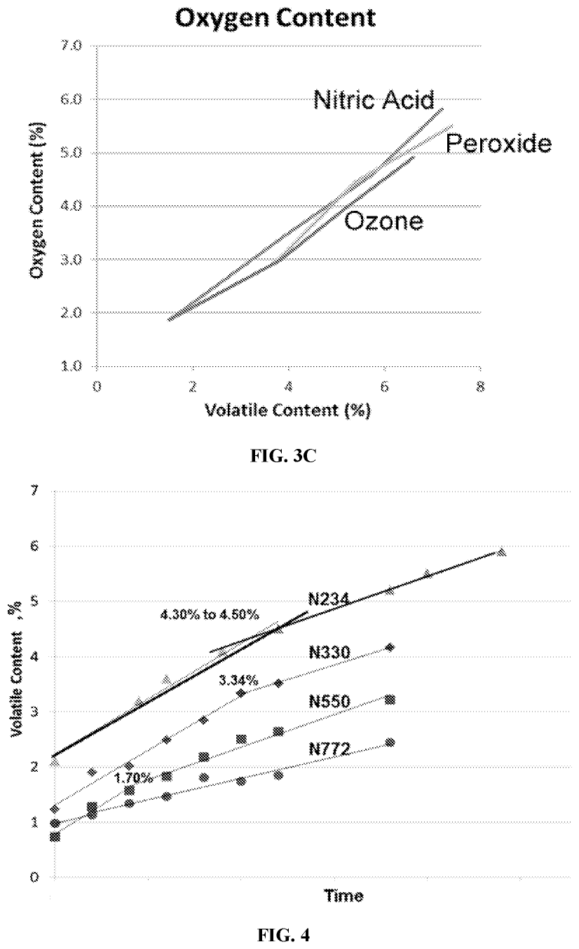

Processes such as nitric acid and hydrogen peroxide, if applied aggressively to fully functionalize the carbon black edge sites, may begin to over-oxidize the carbon black and introduce porosity, which can reduce the specific gravity of the carbon black. As illustrated in FIGS. 3A and 3B, the nitrogen surface area and statistical thickness surface area or non-porous surface area (ASTM D6556-16) are plotted versus volatile content for an ASTM N234 grade carbon black, as treated with nitric acid, hydrogen peroxide and ozone. Note that the volatile content of carbon black is frequently used as an indicator of the amount of oxygen based functional groups on the surface of carbon black. In one aspect, this technique is a thermal desorption method designed to liberate oxygen-based functional groups and hydrogen as hydrogen (H₂), CO and CO₂. As a group, these three molecules determine the Volatile level of the carbon black and can directly correlate to the amount of oxygen bound to the surface of the carbon black as oxygen-based functional groups. Typically, a sample of carbon black is placed in a self-sealing quartz crucible and heated to 125° C. for one hour to remove any adsorbed moisture, cooled and weighed, and then put back into the furnace set at 950° C. and held in the oven at that temperature for an additional 15 minutes to devolatilize the sample. The weight loss after moisture devolatilization represents the Volatile content of the carbon black. (see internal method of Birla Carbon). In FIG. 3A, the NSA increases dramatically for nitric acid and hydrogen peroxide treatment and the same is true for the STSA. This characteristic of increased porosity with a higher degree of oxidation is not a preferred characteristic for carbon blacks used in low hysteresis rubber compounds, due to the increase in the number of aggregates per unit volume that leads to enhanced networking of the carbon black (the main source of hysteresis in a rubber compound).

On the other hand, an oxidant, such as ozone, can provide a good method to fully oxidize the edge sites while imparting little or no porosity in the carbon black. In FIGS. 3A and 3B, the NSA and STSA change little with higher degrees of oxidation as a result of ozone treatment; however, the STSA decreases slightly for the ozone treated N234 as a result of minimal porosity and a lower weight of carbon black in the NSA test as a result of increased surface-oxygen content. FIG. 3C illustrates the increase in oxygen content as a function of volatile content.

The ultimate level of non-porous oxidation can, in various aspects, be dependent on the surface area of the carbon black. Graphene layers at the carbon black surface can also affect the level of oxidation since functionalization occurs at edge sites along the graphene sheets. FIG. 4 illustrates exemplary volatile contents of various ASTM grades of carbon black. Breakpoints in the plots for each grade demonstrate the presence of two rates: an initial faster rate that can be related to full oxidation of available edge sites, and a second slower rate wherein monoatomic oxygen functional groups are converted to polyatomic oxygen functional groups. The initial faster rates are similar for the N234, N330, and N550 carbon black grades.

In one aspect, ozonation can allow production of a wide range of carbon blacks with the same amount of oxygen functional groups per square meter of surface area without porosity. This is possible due to the findings that the graphene layers at the surface of the carbon black are similar in dimension (x−y) in the range of 2.5 to 3.5 nm. Thus, the use of ozone and of the similarity in graphene surface layer coverage and size can be important in achieving the goal of a fully oxidized surface with little or no porosity increase. Such a carbon black can, in various aspects, provide a statistically optimum interaction of the carbon black with its surroundings, for example in liquid and polymer systems.

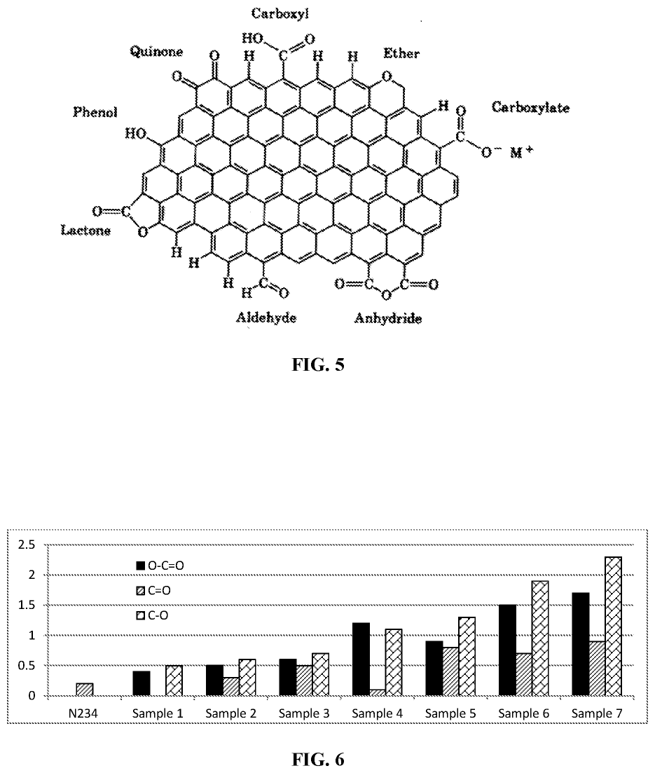

It is well accepted that functional groups on the surface of oxidized carbon blacks typically comprise a mixture of various oxygen-based groups and hydrogen, as illustrated in FIG. 5. Understanding the type, number, and spatial distribution of functional groups on the surface of a carbon black can be helpful in understanding the interaction of the carbon black with its surroundings, whether exposed to atmosphere, or mixed in a liquid, plastic, or rubber system. In rubber systems, this information can facilitate an optimization of interactions and the rubber compound's viscoelastic properties.

### Method for Preparing Functionalized Carbon Black

In consideration of determining the point in which all edge sites are functionalized with oxygen—based functional groups, the molecular dimensions of the surface graphene layers of carbon black can be determined to identify the possible number of reactive sites per nanometer of edge length. Correspondingly a model can be developed to determine the point of full or partial reaction of each edge site and then compared to volatile and oxygen data as confirmation of a fully oxidized carbon black considering oxygen-based functional groups at the edge sites only, without considering porosity.

In one aspect, the models described herein utilize the measured volatile content as a method to validate one or more surface characteristics of a carbon black. It is known that the volatile content of a carbon black is related to the surface area of the carbon black and the level of oxidation of the carbon black. The volatile content can also be influenced by the size of graphitic planes and/or graphene layers at the carbon black surface, along with the number of edge sites that are exposed and available for reaction. Thus, the volatile content of a carbon black can be viewed as, for example, a function of the carbon black's surface area, occupied edge sites, and Lₐ.

Other factors that can be useful in understanding the volatile content of a carbon black can include, for example, carbon black crystallographic models, d(002), L_{c}, and Lₐ spacing. Traditional carbon blacks have been studied using x-ray diffraction and Raman spectroscopy techniques. As noted above, Lₐ (i.e., x−y dimension) ranges from about 2.5 nm to about 3.2 nm for carbon blacks, and shows no direct trend with either increasing particle size or decreasing specific surface area. Lₐ does generally increase with increasing graphitization temperature. Similarly, d002 (XRD graphene layer spacing) is observed to decrease with increasing graphitization temperature. L_{c}, the average crystal stacking height, is observed to increase with increasing particle size or decreasing surface area. L_{c} changes are generally believed to occur after long heat history.

In another aspect, the number of available edge sites per nm along the edge of a surface graphene layer can be useful in determining the number of oxygen atoms on the surface. These values can be determined from known bond distances and the geometry of graphene sheet edges. Using a square geometry model, there are approximately 4.07 edge sites per nm for a graphene layer in a zig-zag conformation. In a chair conformation, the number of edge sites per nm is approximately 4.69.

As noted above, oxidation of a carbon black, such as, for example, ASTM N234, can occur in two phases. In an initial faster phase, the oxidation level rises quickly as the active sites along the graphene surface layers are fully oxidized. Later, a slower phase occurs as fewer and fewer active remain available for oxidation and perhaps some functional groups transition to higher oxidation levels and more poly-atomic oxygen groups.

One technique that can be useful for determining the amount and type of functional groups on the surface of carbon black is x-ray photoelectron spectroscopy (XPS). This technique can determine the atomic percent of elements at the surface of a carbon black sample, as well as the type of functional group based on binding energies of the atoms forming a functional group. In various aspects, this technique has proven useful in the analysis of carbon black surfaces. When an ASTM N234 carbon black with progressively increasing volatile levels is analyzed via XPS, the atomic oxygen concentration exhibits an expected increase with volatile level.

Table 1. XPS Atomic Concentrations with Increasing Surface Oxygen Content

The chemical state of carbon can be determined by XPS. The resulting data is illustrated in Table 1, below, and in FIG. 6, showing a steady increase in C—O concentration and a later increase in O—C═O concentrations for the samples exhibiting higher volatile levels.

TABLE 1
Carbon Chemical States with Increasing Surface Oxygen
XPS Atomic Percent

| | | | | | | Ratio C—O + |
|---|---|---|---|---|---|---|
| Sample | C—C | C—O | C═O | O—C═O | Oₜₒₜₐₗ | C═O:O—C═O |
| N234 | 98.2 | 0 | 0.2 | 0 | 0.9 | 100/0 |
| Sample 1 | 96.0 | 0.5 | 0 | 0.4 | 2.6 | 56/44 |
| Sample 2 | 94.7 | 0.6 | 0.3 | 0.5 | 3.4 | 64/36 |
| Sample 3 | 94.2 | 0.7 | 0.5 | 0.6 | 3.6 | 67/33/ |
| Smaple 4 | 91.9 | 1.1 | 0.1 | 1.2 | 5.0 | 50/50 |
| Sample 5 | 90.7 | 1.3 | 0.8 | 0.9 | 5.7 | 70/30 |
| Sample 6 | 88.8 | 1.9 | 0.7 | 1.5 | 6.6 | 63/37 |
| Sample 7 | 86.3 | 2.3 | 0.9 | 1.7 | 8.3 | 65/35 |

In general, it can be expected that C—O and C═O groups will yield CO, and that O—C═O groups will yield CO₂ in the volatile that is liberated in the volatile test procedure. For example, it has been surmised that the CO in the volatile content (gases) arise from carbonyl (C═O), phenol (C—OH), ether (C—O—C) and quinone (O═C—C═O) groups, while CO₂ can arise from carboxylic acids (O═C—OH) and lactone (O—C═O) groups. Carboxylic anhydrides can also yield both CO and O—C═O groups. The above would indicate that the ratio of CO and CO₂ can range from about 50:50 up to about 70:30, but it is possible that certain C═O groups can even yield CO₂ due to close proximity of the carbon black aggregates and functional groups.

### Carbon Black Surface Models

Using the above information regarding the nature and composition of the volatile content, along with the potential number of active sites available for oxidation and the number of oxygen atoms required to fully occupy the edge sites of the surface graphene layers, equations have been developed that relate the surface area, Lₐ dimension and shape of the graphene layers (square), number of edge sites at the perimeter of the surface layers and the composition of the volatile content. This approach can be used to determine, for example, the equilibrium volatile content for a given carbon black sample.

An initial step in calculating the equilibrium volatile content modelling the carbon black surface is to select a surface model. One model, the Graphitic Crystal Model, assumes that all graphene edge sites are available, with no overlap, as illustrated in FIG. 1. A second model, the Paracrystalline Model, assumes some degree of overlap of graphene layers, thus impacting the number of active sites available depending upon the degree of overlap. Surprisingly, the model shows that more edge sites are available the higher the degree of overlap.

Both models assume a square geometry. In each model, the equations comprise two primary factors: one for monoatomic oxygen functional groups, and a second for polyatomic oxygen functional groups, and can be expressed as:

PEV=(Monoatomic Oxygen Component)+(Polyatomic Oxygen Component) (1)

### Model 1: Graphitic Crystal Model

In the Graphitic Crystal Model, the carbon black surface area is divided by different Lₐ sizes to obtain the number of graphitic layers at the surface, and thus, the total number of edge sites.

The Monoatomic Oxygen Component (MOC) for the Graphitic Crystal Model is shown below, as equation (2):

$$MOC = [ [ [ \frac{( \frac{SSA}{{La}^{2}} ) ( La \times PM \times 4.38 ) ( NSO \times 16 )}{( 6.022 \times 1 {0}^{23} )} ] \times \frac{{R}_{CO}}{0.5714} ] ] \times 100 \qquad ( 2 )$$

wherein SSA=Specific Surface Area; Lₐ=x−y dimension of average crystallite from x-ray diffraction; PM=Perimeter Model (PM_{Square}=4); 4.38=number of edge sites per nm of graphene layer edge; NSO=Number of Sites Occupied (0 to 1); 16=16 g atomic weight of oxygen; R_{CO}, R_{CO2}=Ratio of CO or CO₂ in Volatile (0 to 1); and 6.022×10²³=Avogadro's Number.

The Polyatomic Oxygen Component (POC) for the Graphitic Crystal Model is shown below, as equation (3):

$$POC = [ [ 2 \times [ \frac{( \frac{SSA}{{La}^{2}} ) ( La \times PM \times 4.38 ) ( NSO \times 16 )}{( 6.022 \times 1 {0}^{23} )} ] \times \frac{{R}_{CO}}{0.7272} ] ] \times 100 \qquad ( 3 )$$

wherein SSA=Specific Surface Area; Lₐ=x−y dimension of average crystallite from x-ray diffraction; PM=Perimeter Model (PM_{Square}=4); 4.38=number of edge sites per nm of graphene layer edge; NSO=Number of Sites Occupied (0 to 1); 16=16 g atomic weight of oxygen; R_{CO}, R_{CO2}=Ratio of CO or CO₂ in Volatile (0 to 1); and 6.022×10²³=Avogadro's Number.

The

$$( \frac{SSA}{{La}^{2}} )$$

factor represents the number of graphene layers at the surface per gram of carbon black. The (Lₐ×PM×4.38) factor represents the number of edge sites (i.e., oxygen atoms) along the perimeter of one surface graphene layer. Thus,

$$( \frac{SSA}{{La}^{2}} ) ( La \times PM \times 4.38 )$$

represents the total number of edge sites (i.e., oxygen atoms) at the surface per gram of carbon black. When multiplied by (NS0×16) and divided by Avogadro's number, this factor represents the weight of oxygen atoms per gram of carbon black. Finally, this portion of the equation is multiplied by either

$$\frac{{R}_{CO}}{0.5714} or \frac{{R}_{{CO}_{2}}}{0.7272}$$

to yield the fraction of CO or CO₂, respectively, in the volatile.

Thus, the complete Graphitic Crystal Model is shown below, as equation (4):

$$[ [ [ \frac{( \frac{SSA}{{La}^{2}} ) ( La \times PM \times 4.38 ) ( NSO \times 16 )}{( 6.022 \times 1 {0}^{23} )} ] \times \frac{{R}_{CO}}{0.5714} ] + [ 2 \times [ \frac{( \frac{SSA}{{La}^{2}} ) ( La \times PM \times 4.38 ) ( NSO \times 16 )}{( 6.022 \times 1 {0}^{23} )} ] \times \frac{{R}_{{CO}_{2}}}{0.7272} ] ] \times 100 \qquad ( 4 )$$

From this model a calculation of the amount of oxidation and resulting volatile content as function of the number of edge sites oxidized, either partially oxidized or fully oxidized is possible. This value can then be compared to actual volatile values from experimental data, allowing a correlation to the number of edge sites that are oxidized. In this way the “equilibrium volatile level” can be determined, where it is considered that all edge sites that are exposed at the surface are oxidized, no more and no less.

Table 2 shows the Predicted Equilibrium Volatile (PEV) content, wherein 100% of graphene edge sites are occupied at the breakpoint in the volatile concentration curve, as in FIG. 4. The convergence of the surface model equation and the experimental data strongly suggests that the edge sites have indeed been fully oxidized. Note in Table 2 that within the Volatile Range predicted by XPS (55/45 to 70/30) the Volatile at the breakpoint can be predicted when the La value is in the range of 2.25 to 2.50. Smaller La values over predict and larger La values under-predict the Volatile.

TABLE 2
Predicted Equilibrium Volatile (4) as a Function of the Number of Edge Sites Occupied
and the non-porous Surface Area (STSA, nm²/g) and Lₐ (nm), assuming a Square Perimeter
Model, 100% of Sites Occupied, and an XPS determined Volatile Ratio (CO/CO₂) of
70/30, 62.5/37.5 and 55/45.

| | | 100% Sites Occupied | | | | | | | |
|---|---|---|---|---|---|---|---|---|---|
| | | La, nm | 2.00 | 1 | ← fractional coverage constant | | | | |
| | | STSA, nm²/g | | 2.25 | 2.50 | 2.75 | 3.00 | 3.25 | 3.50 |
| | SQUARE (No Edge Sites * 4; 4.38 sites per nm); 70/30 CO/CO2 on Surface XPS | | | | | | | | |
| 112 | N234 | 1.12E+20 | 5.34 | 4.75 | 4.28 | 3.89 | 3.56 | 3.29 | 3.05 |
| 106 | N220 | 1.06E+20 | 5.06 | 4.50 | 4.05 | 3.68 | 3.37 | 3.11 | 2.89 |
| 75 | N330 | 7.5E+19 | 3.58 | 3.18 | 2.86 | 2.60 | 2.39 | 2.20 | 2.04 |
| 39 | N550 | 3.9E+19 | 1.86 | 1.65 | 1.49 | 1.35 | 1.24 | 1.15 | 1.06 |
| 28 | N762 | 2.8E+19 | 1.34 | 1.19 | 1.07 | 0.97 | 0.89 | 0.82 | 0.76 |
| | SQUARE (No Edge Sites * 4; 4.38 sites per nm); 62.570/37.5 CO/CO2 on Surface XPS | | | | | | | | |
| 112 | N234 | 1.12E+20 | 5.54 | 4.92 | 4.43 | 4.03 | 3.69 | 3.41 | 3.17 |
| 106 | N220 | 1.06E+20 | 5.24 | 4.66 | 4.19 | 3.81 | 3.50 | 3.23 | 3.00 |
| 75 | N330 | 7.5E+19 | 3.71 | 3.30 | 2.97 | 2.70 | 2.47 | 2.28 | 2.12 |
| 39 | N550 | 3.9E+19 | 1.93 | 1.71 | 1.54 | 1.40 | 1.29 | 1.19 | 1.10 |
| 28 | N762 | 2.8E+19 | 1.38 | 1.23 | 1.11 | 1.01 | 0.92 | 0.85 | 0.79 |
| | SQUARE (No Edge Sites * 4; 4.38 sites per nm); 55/45 CO/CO2 on Surface XPS | | | | | | | | |
| 112 | N234 | 1.12E+20 | 5.74 | 5.10 | 4.59 | 4.17 | 3.82 | 3.53 | 3.28 |
| 106 | N220 | 1.06E+20 | 5.43 | 4.82 | 4.34 | 3.95 | 3.62 | 3.34 | 3.10 |
| 75 | N330 | 7.5E+19 | 3.84 | 3.41 | 3.07 | 2.79 | 2.56 | 2.36 | 2.19 |
| 39 | N550 | 3.9E+19 | 2.00 | 1.78 | 1.60 | 1.45 | 1.33 | 1.23 | 1.14 |
| 28 | N762 | 2.8E+19 | 1.43 | 1.27 | 1.15 | 1.04 | 0.96 | 0.88 | 0.82 |

Table 3 shows the Predicted Equilibrium Volatile (PEV) content, wherein 75% of graphene edge sites are occupied at the breakpoint in the volatile concentration curve, as in FIG. 4. The surface model equation and the experimental data strongly suggests that the edge sites, if only 75% occupied, fall well short of predicting the Volatile breakpoint, giving support to the conclusion that 100% of the edge sites have indeed been fully oxidized.

TABLE 3
Predicted Equilibrium Volatile (4) as a Function of the Number of Edge Sites Occupied and
the non-porous Surface Area (STSA, nm²/g) and Lₐ (nm), assuming a Square Perimeter Model,
75% of Sites Occupied, and an XPS determined Volatile Ratio (CO/CO2) of 70/30, 62.5/37.5.

| | | 75% Sites Occupied | | | | | | | |
|---|---|---|---|---|---|---|---|---|---|
| | | La, nm | 2.00 | 0.75 | ← fractional coverage constant | | | | |
| | | STSA, nm²/g | | 2.25 | 2.50 | 2.75 | 3.00 | 3.25 | 3.50 |
| | SQUARE (No Edge Sites * 4; 4.38 sites per nm); 70/30 CO/CO2 on Surface XPS | | | | | | | | |
| 112 | N234 | 1.12E+20 | 4.01 | 3.56 | 3.21 | 2.92 | 2.67 | 2.47 | 2.29 |
| 106 | N220 | 1.06E+20 | 3.79 | 3.37 | 3.03 | 2.76 | 2.53 | 2.33 | 2.17 |
| 75 | N330 | 7.5E+19 | 2.68 | 2.39 | 2.15 | 1.95 | 1.79 | 1.65 | 1.53 |
| 39 | N550 | 3.9E+19 | 1.40 | 1.24 | 1.12 | 1.02 | 0.93 | 0.86 | 0.80 |
| 28 | N762 | 2.8E+19 | 1.00 | 0.89 | 0.80 | 0.73 | 0.67 | 0.62 | 0.57 |
| | SQUARE (No Edge Sites * 4; 4.38 sites per nm); 62.570/37.5 CO/CO2 on Surface XPS | | | | | | | | |
| 112 | N234 | 1.12E+20 | 4.15 | 3.69 | 3.32 | 3.02 | 2.77 | 2.56 | 2.37 |
| 106 | N220 | 1.06E+20 | 3.93 | 3.50 | 3.15 | 2.86 | 2.62 | 2.42 | 2.25 |
| 75 | N330 | 7.5E+19 | 2.78 | 2.47 | 2.23 | 2.02 | 1.85 | 1.71 | 1.59 |
| 39 | N550 | 3.9E+19 | 1.45 | 1.29 | 1.16 | 1.05 | 0.96 | 0.89 | 0.83 |
| 28 | N762 | 2.8E+19 | 1.04 | 0.92 | 0.83 | 0.76 | 0.69 | 0.64 | 0.59 |
| | SQUARE (No Edge Sites * 4; 4.38 sites per nm); 55/45 CO/CO2 on Surface XPS | | | | | | | | |
| 112 | N234 | 1.12E+20 | 4.30 | 3.82 | 3.44 | 3.13 | 2.87 | 2.65 | 2.46 |
| 106 | N220 | 1.06E+20 | 4.07 | 3.62 | 3.26 | 2.96 | 2.71 | 2.51 | 2.33 |
| 75 | N330 | 7.5E+19 | 2.88 | 2.56 | 2.30 | 2.09 | 1.92 | 1.77 | 1.65 |
| 39 | N550 | 3.9E+19 | 1.50 | 1.33 | 1.20 | 1.09 | 1.00 | 0.92 | 0.86 |
| 28 | N762 | 2.8E+19 | 1.08 | 0.96 | 0.86 | 0.78 | 0.72 | 0.66 | 0.61 |

### Model 2: Paracrystalline Overlap Model

In the Paracrystalline Overlap Model, Lₐ and overlap vary and the number of edge sites per nanometer of exposed graphene layer is determined on a per nm² basis.

The Monoatomic Oxygen Component (MOC) for the Paracrystalline Overlap Model is shown below, as equation (5):

$$MOC = [ [ [ \frac{( SSA ) ( NES ) ( NSO \times 16 )}{( 6.022 \times 1 {0}^{23} )} ] \times \frac{{R}_{CO}}{0.5714} ] ] \times 100 \qquad ( 5 )$$

wherein SSA=Specific Surface Area; NES=the number of edge sites (i.e., oxygen atoms) per nm²; NSO=Number of Sites Occupied (0 to 1); 16=16 g atomic weight of oxygen; R_{CO}, R_{CO2}=Ratio of CO or CO₂ in Volatile (0 to 1); and 6.022×10²³=Avogadro's Number.

The Polyatomic Oxygen Component (POC) for the Paracrystalline Overlap Model is shown below, as equation (6):

$$POC = [ [ 2 \times [ \frac{( SSA ) ( NES ) ( NSO \times 16 )}{( 6.022 \times 1 {0}^{23} )} ] \times \frac{{R}_{CO}}{0.7272} ] ] \times 100 \qquad ( 6 )$$

wherein SSA=Specific Surface Area; NES=the number of edge sites (i.e., oxygen atoms) per nm²; NSO=Number of Sites Occupied (0 to 1); 16=16 g atomic weight of oxygen; R_{CO}, R_{CO2}=Ratio of CO or CO₂ in Volatile (0 to 1); and 6.022×10²³=Avogadro's Number.

The (SSA×NES×NSO×16)/(6.022×10²³) factor represents the weight of oxygen atoms per gram of carbon black. When multiplied by either

$$\frac{{R}_{CO}}{0.5714} or \frac{{R}_{{CO}_{2}}}{0.7272} ,$$

the result represents the fraction of CO or CO₂, respectively, in the volatile.

Thus, the complete Paracrystalline Overlap Model is shown below, as equation (7):

$$[ [ [ \frac{( SSA ) ( NES ) ( NSO \times 16 )}{( 6.022 \times 1 {0}^{23} )} ] \times \frac{{R}_{CO}}{0.5714} ] + [ 2 \times [ \frac{( SSA ) ( NES ) ( NSO \times 16 )}{( 6.022 \times 1 {0}^{23} )} ] \times \frac{{R}_{{CO}_{2}}}{0.7272} ] ] \times 100 \qquad ( 7 )$$

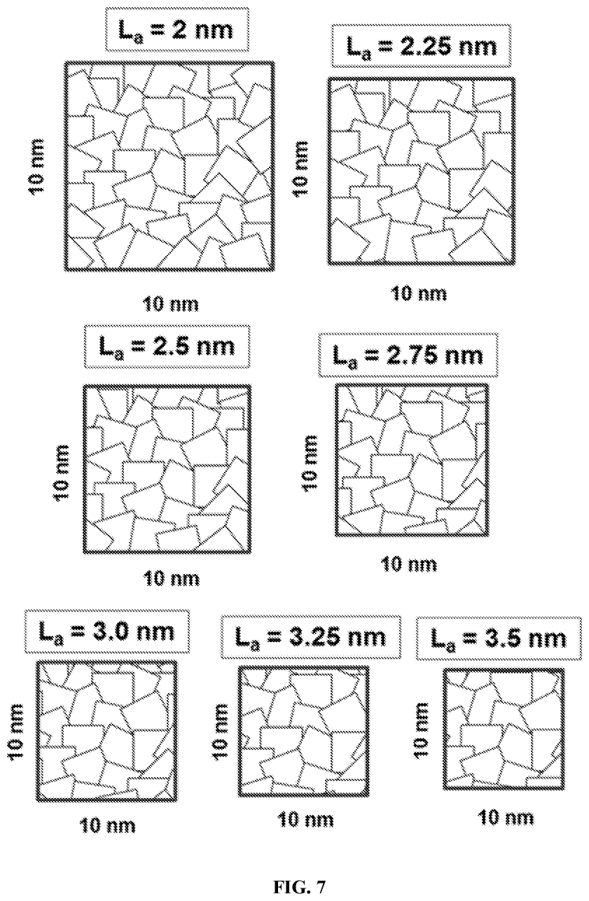

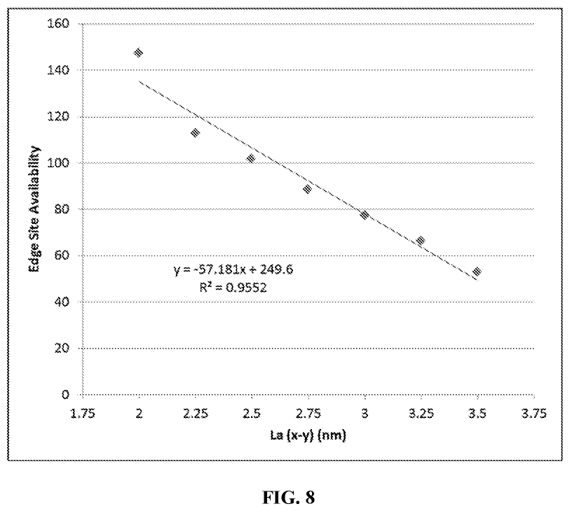

If the graphene layer overlap is assumed to be 50%, the Lₐ variation can be obtained by decreasing the box size for the same surface model of overlapping graphene layers, as illustrated in FIG. 7 for Lₐ values ranging from 2 nm to 3.5 nm. The edge site distance for each varying Lₐ size is detailed in Table 4, below. A summary plot of edge site availability with varying Lₐ size for the Paracrystalline Overlap Model is illustrated in FIG. 8.

TABLE 4
Edge Site Distance with Varying Lₐ
Decreasing Box Size

| | Edge Site |
|---|---|
| Lₐ (x-y) | Distance |
| [nm] | [nm] |
| 2.00 | 147.2 |
| 2.25 | 113.0 |
| 2.50 | 101.5 |
| 2.75 | 88.3 |
| 3.00 | 77.2 |
| 3.25 | 66.3 |
| 3.50 | 53.0 |

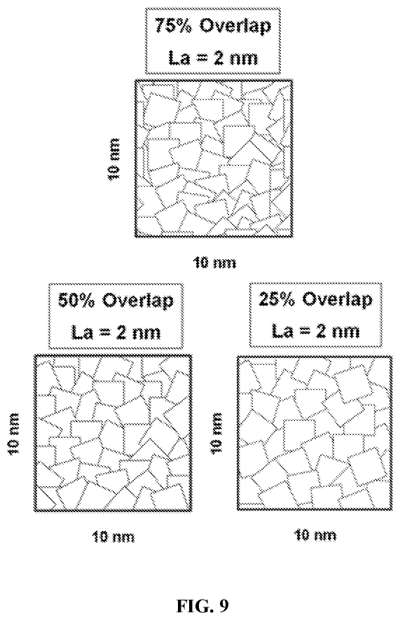

Similarly, other degrees of graphene layer overlap can significantly change the number of calculated, exposed edge sites. An illustration of varying degrees of overlap (i.e., 75%, 50%, and 25%), all having the same Lₐ (i.e., 2 nm), is illustrated in FIG. 9.

The edge site distance, total number of edge sites, and number of edge sites per nm², for a surface model having 75% overlap of graphene layers, is detailed in Table 5, below. It should be noted that the number of exposed edge sites is directly related to the degree of graphene layer overlap.

TABLE 5
Edge Sites for 75% Graphene Layer Overlap

| | | Edge Site | Total Sites | Sites |
|---|---|---|---|---|
| La (x-y) | La (x-y) | Distance | Counted | per nm² |
| [nm] | [pixels/nm] | [nm] | — | — |
| 2 | 29.8 | 194.8 | 853.1 | 8.53 |
| 2.25 | 29.8 | 149.4 | 654.4 | 6.54 |
| 2.5 | 29.8 | 123.2 | 539.6 | 5.40 |
| 2.75 | 29.8 | 110.6 | 484.3 | 4.84 |
| 3 | 29.8 | 80.6 | 353.0 | 3.53 |
| 3.25 | 29.8 | 72.5 | 317.5 | 3.17 |
| 3.5 | 29.8 | 65.5 | 286.9 | 2.87 |

The breakpoint volatile content (i.e., equilibrium volatile content) for a model having 75% graphene layer overlap, an Lₐ in the range from 2.0 to 2.25, assuming 100% of the available edge sites are functionalized, is detailed in Table 6, below. This model is in good agreement with the Graphitic Crystal Model in that an La in the range of 2.00 to 2.25 nm predicts the correct Volatile level at the breakpoint.

TABLE 6
Predicted Breakpoint Volatile Level for 75% Graphene Layer Overlap with
100% Sites Occupied in a 62.5/37.5 Ratio of XPS C—O + C═)/O—C═O.

| 100% Sites Occupied, 75% Overlap on Avg | | | | | | | | | |
|---|---|---|---|---|---|---|---|---|---|
| | | Sites per | 8.53 | 1 | ← fractional coverage | | | | |
| | | La, nm | 2.00 | 6.54 | 5.4 | 4.84 | 3.53 | 3.17 | 2.87 |
| | | STSA, nm²/g | | 2.25 | 2.50 | 2.75 | 3.00 | 3.25 | 3.50 |
| 112 | N234 | 1.12E+20 | 5.39 | 4.14 | 3.41 | 3.06 | 2.23 | 2.00 | 1.81 |
| 106 | N220 | 1.06E+20 | 5.11 | 3.91 | 3.23 | 2.90 | 2.11 | 1.90 | 1.72 |
| 75 | N330 | 7.5E+19 | 3.61 | 2.77 | 2.29 | 2.05 | 1.49 | 1.34 | 1.22 |
| 39 | N550 | 3.9E+19 | 1.88 | 1.44 | 1.19 | 1.07 | 0.78 | 0.70 | 0.63 |
| 28 | N762 | 2.8E+19 | 1.35 | 1.03 | 0.85 | 0.77 | 0.56 | 0.50 | 0.45 |

The edge site distance, total number of edge sites, and number of edge sites per nm², for a surface model having 50% overlap of graphene layers, is detailed in Table 7, below.

TABLE 7
Edge Sites for 50% Graphene Layer Overlap

| | | Edge Site | Total Sites | Sites |
|---|---|---|---|---|
| La (x-y) | La (x-y) | Distance | Counted | per nm² |
| [nm] | [pixels/nm] | [nm] | — | — |
| 2 | 29.8 | 147.2 | 644.74 | 6.45 |
| 2.25 | 29.8 | 113.0 | 494.94 | 4.95 |
| 2.5 | 29.8 | 101.5 | 444.57 | 4.45 |
| 2.75 | 29.8 | 88.3 | 386.75 | 3.87 |
| 3 | 29.8 | 77.2 | 338.14 | 3.38 |
| 3.25 | 29.8 | 66.3 | 290.39 | 2.90 |
| 3.5 | 29.8 | 53.0 | 232.14 | 2.32 |

The breakpoint volatile content (i.e., equilibrium volatile content) for a model having 50% graphene layer overlap, is detailed in Table 8, below. The Paracrystalline Overlap Model under predicts the volatile breakpoint level for carbon blacks having a 50% graphene layer overlap.

TABLE 8
Predicted Breakpoint Volatile Level for 50% Graphene Layer Overlap with
100% Sites Occupied in a 62.5/37.5 Ratio of XPS C—O + C═)/O—C═O.

| 100% Sites Occupied, 50% Overlap on Avg | | | | | | | | | |
|---|---|---|---|---|---|---|---|---|---|
| | | Sites per | 6.45 | 1 | ← fractional coverage | | | | |
| | | La, nm | 2.00 | 4.95 | 4.45 | 3.87 | 3.38 | 2.9 | 2.32 |
| | | STSA, nm²/g | | 2.25 | 2.50 | 2.75 | 3.00 | 3.25 | 3.50 |
| 112 | N234 | 1.12E+20 | 4.08 | 3.13 | 2.81 | 2.45 | 2.14 | 1.83 | 1.47 |
| 106 | N220 | 1.06E+20 | 3.86 | 2.96 | 2.66 | 2.32 | 2.02 | 1.74 | 1.39 |
| 75 | N330 | 7.5E+19 | 2.73 | 2.10 | 1.88 | 1.64 | 1.43 | 1.23 | 0.98 |
| 39 | N550 | 3.9E+19 | 1.42 | 1.09 | 0.98 | 0.85 | 0.74 | 0.64 | 0.51 |
| 28 | N762 | 2.8E+19 | 1.02 | 0.78 | 0.70 | 0.61 | 0.53 | 0.46 | 0.37 |

The edge site distance, total number of edge sites, and number of edge sites per nm², for a surface model having 25% overlap of graphene layers, is detailed in Table 9, below.

TABLE 9
Edge Sites for 25% Graphene Layer Overlap

| | | Edge Site | Total Sites | Sites |
|---|---|---|---|---|
| La (x-y) | La (x-y) | Distance | Counted | per nm² |
| [nm] | [pixels/nm] | [nm] | — | — |
| 2 | 29.8 | 130.5 | 571.6 | 5.72 |
| 2.25 | 29.8 | 107.6 | 471.4 | 4.71 |
| 2.5 | 29.8 | 94.3 | 412.9 | 4.13 |
| 2.75 | 29.8 | 76.9 | 336.9 | 3.37 |
| 3 | 29.8 | 61.9 | 271.3 | 2.71 |
| 3.25 | 29.8 | 56.3 | 246.6 | 2.47 |
| 3.5 | 29.8 | 48.8 | 213.9 | 2.14 |

The breakpoint volatile content (i.e., equilibrium volatile content) for a model having 25% graphene layer overlap, is detailed in Table 10, below. The Paracrystalline Overlap Model under predicts the volatile breakpoint level for carbon blacks having a 25% graphene layer overlap.

TABLE 10
Predicted Breakpoint Volatile Level for 25% Graphene Layer Overlap with
100% Sites Occupied in a 62.5/37.5 Ratio of XPS C—O + C═)/O—C═O.

| 100% Sites Occupied, 25% Overlap on Avg | | | | | | | | | |
|---|---|---|---|---|---|---|---|---|---|
| | | Sites per | 5.72 | 1 | ← fractional coverage | | | | |
| | | La, nm | 2.00 | 4.71 | 4.13 | 3.37 | 2.71 | 2.47 | 2.14 |
| | | STSA, nm²/g | | 2.25 | 2.50 | 2.75 | 3.00 | 3.25 | 3.50 |
| 112 | N234 | 1.12E+20 | 3.62 | 2.98 | 2.61 | 2.13 | 1.71 | 1.56 | 1.35 |
| 106 | N220 | 1.06E+20 | 3.42 | 2.82 | 2.47 | 2.02 | 1.62 | 1.48 | 1.28 |
| 75 | N330 | 7.5E+19 | 2.42 | 1.99 | 1.75 | 1.43 | 1.15 | 1.05 | 0.91 |
| 39 | N550 | 3.9E+19 | 1.26 | 1.04 | 0.91 | 0.74 | 0.60 | 0.54 | 0.47 |
| 28 | N762 | 2.8E+19 | 0.90 | 0.74 | 0.65 | 0.53 | 0.43 | 0.39 | 0.34 |

From this model determination of the amount of oxidation and resulting volatile content as function of the number of edge sites oxidized, either partially oxidized or fully oxidized is possible. This value can then be compared to actual volatile values from experimental data, allowing a correlation to the number of edge sites that are oxidized. In this way the “equilibrium volatile level” can be determined, where it is considered that all edge sites that are exposed at the surface are oxidized, no more and no less.

Thus, in one aspect, the present disclosure provides a method for determining the equilibrium level of functionalization for a specific grade of carbon black. In another aspect, experimental data can be used to confirm any one or more of the models described herein. Based on the models described herein and optionally, on experimental data, one of skill in the art can treat a carbon black sample so as to functionalize the carbon black to a predetermined level, for example, about 80%, about 85%, about 90%, about 92%, about 94%, about 95% , about 96%, about 97%, about 98%, about 99%, or about 100% of the equilibrium value. In other aspects, a carbon black can be functionalized to a level greater than the predetermined equilibrium value, while minimizing added porosity. In such cases, a carbon black can be functionalized to a level of about 101%, 102%, 103%, 104%, 105%, 106%, 107%, 108%, 109%, 110%, 112%, 114%, 116%, 118%, or 120%.

Applications of Carbon Black having Equilibrium Volatile Content

In various aspects, carbon blacks having an equilibrium volatile content (i.e., about 100% of the predicted equilibrium volatile content value), or a volatile content approximately equal to, for example, a level of about 80%, 85%, 90%, 92%, 94%, 95%, 96%, 97%, 98%, 99%, 101%, 102%, 103%, 104%, 105%, 106%, 107%, 108%, 109%, 110%, 112%, 114%, 116%, 118%, or 120% of the predicted equilibrium value can be prepared. In various aspects, carbon blacks, such as those described herein and/or treated by the methods described herein, can be useful in a number of applications. In one aspect, such a carbon black can be used in any application where a conventional oxidized carbon black would be used. In another aspect, such a carbon black can be useful in an ink or coating application, wherein the carbon black can provide improved color performance (increased jetness). In yet another aspect, such a carbon black can be useful in a rubber application, such as, for example, a rubber formulation for a tire, where the oxidized carbon black can provide improved hysteresis for the resulting rubber compound.

In one aspect, the carbon black of the present invention can comprise any suitable carbon black. In one aspect, the carbon black can comprise an ASTM grade, for example, suitable for use in rubber compounds for tires. In other aspects, the carbon black can comprise a specialty carbon black, for example, typically used in inks, coatings, or plastics applications. One of skill in the art, in possession of this disclosure, would readily be able to select an appropriate carbon black for a given application.

In another aspect, a carbon black having an equilibrium volatile content or a level of about 101%, 102%, 103%, 104%, 105%, 106%, 107%, 108%, 109%, 110%, 112%, 114%, 116%, 118%, or 120% of the predicted equilibrium volatile content, can be used in one or more conventional rubber formulations for a tire. In such aspects, a tire can ultimately be produced using the rubber compound containing the improved carbon black, and can provide improved performance properties over similar tires containing conventional carbon blacks having, for example, lower or higher volatile levels.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. (canceled)

2. A carbon black having from about 80% to about 150% of an equilibrium level of volatile content, as determined by either a graphitic crystal model or a paracrystalline model.

3. The carbon black of claim 2, having from about 80% to about 100% of the equilibrium level of volatile content, as determined by either a graphitic crystal model or a paracrystalline model.

4. (canceled)

5. (canceled)

6. The carbon black of claim 2, having from about 95% to about 100% of the equilibrium level of volatile content, as determined by either a graphitic crystal model or a paracrystalline model.

7. (canceled)

8. (canceled)

9. (canceled)

10. The carbon black of claim 2, having from about 95% to about 105% of the equilibrium level of volatile content, as determined by either a graphitic crystal model or a paracrystalline model.

11. The carbon black of claim 2, having from about 98% to about 102% of the equilibrium level of volatile content, as determined by either a graphitic crystal model or a paracrystalline model.

12. The carbon black of claim 2, having about 100% of the equilibrium level of volatile content, as determined by either a graphitic crystal model or a paracrystalline model.

13. The carbon black of claim 2, wherein the model comprises a graphitic crystal model.

14. The carbon black of claim 2, wherein the model comprises a paracrystalline model.

15. The carbon black of claim 2, wherein the model comprises a paracrystalline model having about 25% graphene layer overlap.

16. The carbon black of claim 2, wherein the model comprises a paracrystalline model having about 50% graphene layer overlap.

17. (canceled)

18. (canceled)

19. A method for preparing a functionalized carbon black, comprising determining an equilibrium level of volatile content, and then functionalizing a carbon black to a range of from about 80% to about 150% of the equilibrium level of volatile content.

20. (canceled)

21. (canceled)

22. The method for preparing a functionalized carbon black of claim 19, wherein the carbon black is functionalized to a range of from about 95% to about 100% of the equilibrium level of volatile content.

23. (canceled)

24. (canceled)

25. (canceled)

26. The method for preparing a functionalized carbon black of claim 19, wherein the carbon black is functionalized to a range of from about 90% to about 110% of the equilibrium level of volatile content.

27. The method for preparing a functionalized carbon black of claim 19, wherein the carbon black is functionalized to a range of from about 95% to about 105% of the equilibrium level of volatile content.

28. The method for preparing a functionalized carbon black of claim 19, wherein the carbon black is functionalized to a range of from about 98% to about 102% of the equilibrium level of volatile content.

29. The method for preparing a functionalized carbon black of claim 19, wherein the carbon black is functionalized to about 100% of the equilibrium level of volatile content.

30. The method of claim 19, wherein one or more samples of a carbon black are oxidized at one or more levels of volatile content to calculate an equilibrium level of volatile content.

31. The method of claim 19, wherein an equilibrium level of volatile content is based on a graphitic crystal model.

32. The method of claim 19, wherein an equilibrium level of volatile content is based on a paracrystalline model.

33. The method of claim 19, wherein an equilibrium level of volatile content is based on a paracrystalline model having about 25% graphene layer overlap.

34. The method of claim 19, wherein an equilibrium level of volatile content is based on a paracrystalline model having about 50% graphene layer overlap.

35. (canceled)

36. The method of claim 19, wherein functionalizing comprises ozonation.

37. The method of claim 19, wherein functionalizing comprises a continuous process.

38. The method of claim 19, wherein functionalizing comprises an in-situ process.

39. The method of claim 19, wherein functionalizing comprises a fluid bed based ozonation process.

40. An ink or coating composition comprising the carbon black of claim 2.

41. An ink or coating composition comprising a carbon black produced by the method of claim 19.

42. A rubber composition comprising the carbon black of any one of claim 2.

43. A rubber composition comprising a carbon black produced by the method of claim 19.

44. The rubber composition of claim 43, comprising one or more conventional rubber formulations suitable for use in a tire.

45. A tire comprising a rubber compound comprising the carbon black of claim 2.

46. A tire comprising a rubber compound comprising a carbon black produced by the method of claim 19.

47. (canceled)

48. A tire comprising a carbon black having, prior to compounding, a volatile content of from about 80% to about 120% of a predicted equilibrium level of volatile content.

49. The tire of claim 48, wherein prior to compounding, the volatile content is from about 85% to about 115% of the predicted equilibrium level of volatile content.

50. (canceled)

51. The tire of claim 48, wherein prior to compounding, the volatile content is from about 95% to about 105% of the predicted equilibrium level of volatile content.

52. The tire of claim 48, wherein prior to compounding, the volatile content is equal to the predicted equilibrium level of volatile content.
